(19) United States
(12) Patent Application Publication
(10) Pub. No.: US 2016/0342861 A1
(43) Pub. Date: Nov. 24, 2016

(54) Method for Training Classifiers to Detect Objects Represented in Images of Target Environments

(71) Applicant: Mitsubishi Electric Research Laboratories, Inc., Cambridge, MA (US)

(72) Inventors: Oncel Tuzel, Winchester, MA (US); Jay Thornton, Watertown, MA (US)

(21) Appl. No.: 14/718,634

(22) Filed: May 21, 2015

(51) Int. Cl. G06K 9/62; G06T 7/40; G06T 7/00; G06T 17/00; G06K 9/46

(52) U.S. Cl. CPC G06K 9/6256; G06T 17/00; G06K 9/6267; G06K 9/46; G06T 7/0051; G06T 7/40

(57) ABSTRACT

A method for training a classifier that is customized to detect and classify objects in a set of images acquired in a target environment, first generates a 3D target environment model from the set of images, and then acquires 3D object models. Training data is synthesized from the target environment model and the 3D object models, and then the classifier is trained using the training data.

### FIELD OF THE INVENTION

The invention relates generally to computer vision, and more particularly to training classifiers to detect and classify objects in images acquired of environments.

### BACKGROUND OF THE INVENTION

Prior art methods for detecting and classifying objects in color and range images of an environment are typically based on training object classifiers using machine learning. Training data are an essential component of machine learning approaches. When the goal is to develop high accuracy systems, it is important that the classification model has a high capacity so that large variations in appearances of objects and the environment can be modeled.

However, high capacity classifiers come with a drawback of overfitting. Overfitting occurs, e.g., when a model describes random error or noise instead of the underlying relationships. Overfitting generally occurs when the model is excessively complex, such as having too many parameters relative to the data being modeled. Consequently, overfitting can result in poor predictive performance, as it can exaggerate minor fluctuations in the data, and has a poor generalization performance. Therefore, there is need for very large datasets to have good generalization performance.

Most prior art methods require extensive manual intervention. For example, a sensor is placed in a training environment to acquire images of objects in the environment. The acquired images are then stored in a memory as training data. For example, a three-dimensional (3D) sensor is arranged in a store to acquire images of customers. Next, the training data are manually annotated, which is called labeling. During labeling, depending on the task, different locations are marked in the data, such as a bounding box containing a person, human joint locations, all pixels in images originating from a person, etc.

For example, to model moderate variations of human appearances in 3D data, it is necessary to model more than 20 joint angles, in addition to rigid transformations, such as camera and object placement, and human shape variations. Therefore a very large 3D dataset is needed for machine learning approaches. It is difficult to collect and store this data. It is also very time consuming to manually label images of humans and mark necessary joint locations. In addition, internal and external parameters of sensors must be considered. Whenever there is a change in sensor specifications, and placement parameters, the training data needs to be reacquired. Also, in many applications the training data are not available until later stages of the design.

Some prior art methods automatically generate training data using computer graphics simulation, e.g., see Shotton et al., “Real-Time Human Pose Recognition in Parts from Single Depth Images,” CVPR, 2011, and Pishchulin et al. “Learning people detection models from few training samples,” CVPR, 2011. Those methods animate 3D human models using software to simulate 2D or 3D image data. The classifiers are then trained using the simulated data, and limited manually labeled real data. In all those prior art methods, the collection of training data and the training are offsite and offline operations. That is, the classifiers are designed and trained at a different location before being deployed by an end user for onsite use and operation in a target environment.

In addition, those methods do not use any simulated or real data representing the actual target environment to which the classifier will be applied during onsite operation. That is, object classifiers, which are trained offsite and offline using data from many environments, model general object and environment variations, even though such variation may not exist in the target environment. Similarly, offsite trained classifiers may miss specific details of the target environment because they do not have the details in the training data.

### SUMMARY OF THE INVENTION

The embodiments of the invention provide a method for training a classifier to detect and classify objects represented in images acquired of a target environment. The method can be used, to detect and count people represented in images using, e.g., a single image, or multiple images (video). The method can be applied to crowded scenes with moderate to heavy occlusion. The method uses computer graphics and machine learning to train classifiers using a combination of synthetic and real data.

In contrast to prior art, during operation, the method obtains a model of the target environment, simulates object models inside the target environment, and trains a classifier that is optimized for the target environment.

Particularly, a method trains a classifier that is customized to detect and classify objects in a set of images acquired in a target environment by first generating a target environment model from the set of images. Three-dimensional object models are also acquired. Training data are synthesized from the target environment model and the 3D object models. The, the training data is used to train the classifier. Subsequently, the classifier is used to detect objects in test images acquired of the environment.

### BRIEF DESCRIPTION OF THE DRAWINGS

FIG. 1 is a block diagram of a method for training a customized classifier for a target environment using a target environment model and 3D object models according to embodiments of the invention;

FIG. 2 is a block diagram of a method for obtaining a target environment model formed of 2D or 3D images using a sensor according to embodiments of the invention;

FIG. 3 is a block diagram of a method for obtaining a target environment model formed of a 3D model using a sensor and 3D reconstruction procedure according to embodiments of the invention;

FIG. 4 is a block diagram of a method for generating training data using a computer graphics simulation that renders a target environment model and 3D object models according to embodiments of the invention;

FIG. 5 is a block diagram of a method for detecting and classifying objects in a target environment using a custom target classifier according to embodiments of the invention;

FIG. 6 is a block diagram of an object classification procedure to detect humans in an image according to embodiments of the invention; and

FIG. 7 is a feature descriptor computed from a depth image according to embodiments of the invention.

### DETAILED DESCRIPTION OF THE EMBODIMENTS

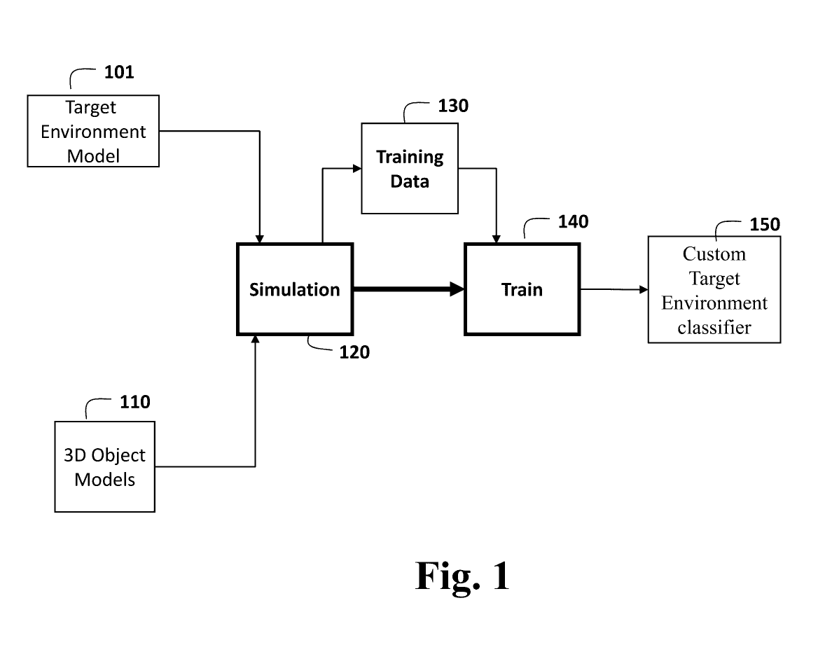

As shown in FIG. 1, the embodiments of our invention provide a method for training 140 a custom target environment classifier 150, which is specialized to detect objects in a target environment. During training, a simulator 120 synthesizes training data 130 from the target environment by using a target environment model 101 and three-dimensional (3D) object models 110. Training data 140 are used to learn the target environment classifier that is customized for detecting objects in the target environment.

As defined herein, the target environment model 101 is for the environment for which the classifier is applied during onsite operation by an end user. For example, the environment is a store, a factory floor, a street scene, a home, and the like.

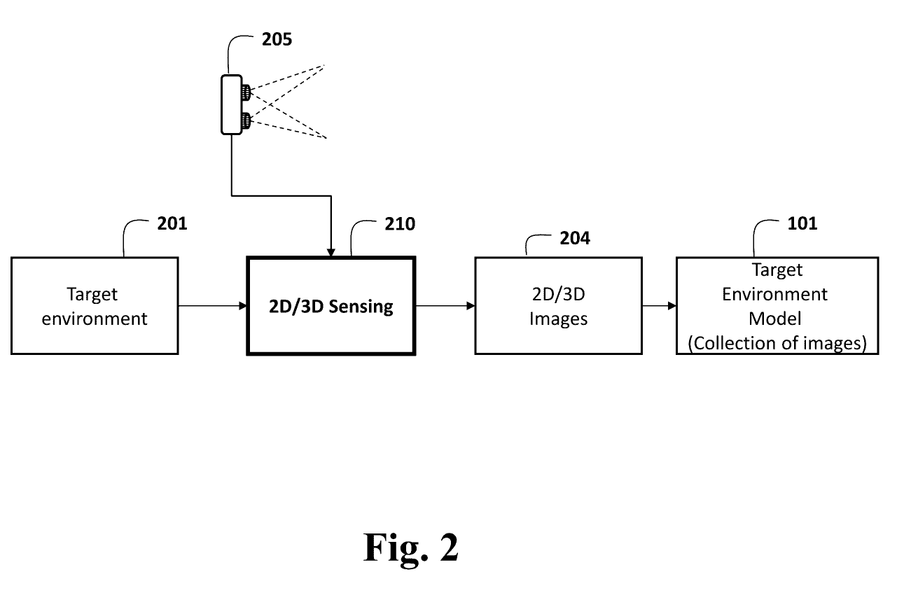

As shown in FIG. 2, the target environment 201 can be sensed 210 in various ways. In one embodiment the target environment model 101 is a collection of two-dimensional (2D) color and 3D depth images 204. This collection can include one or more images. These images are collected using a 2D or 3D sensor 205, or both, placed in the target environment. The sensor(s) can be, for example, a Kinect™ that outputs three-dimensional (3D) range (depth) images, and two-dimensional color images. Alternatively, stereo 2D images acquired by a stereo camera can be used to reconstruct depth values.

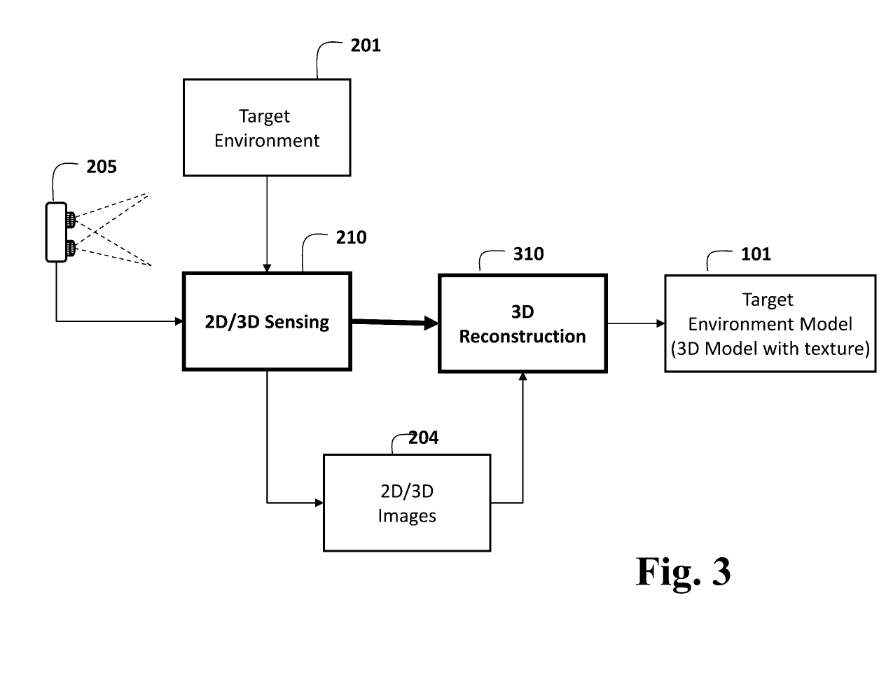

As shown in FIG. 3 for a different embodiment, the target environment model 101 is a 3D model with texture. The target environment is sensed 210 with a 2D or 3D camera 205 to acquire 2D or 3D images 204, or both. The images can be acquired from different viewpoints to reconstruct 310 the entire 3D target environment. The reconstructed model can be stored as a collection of 3D point cloud, or the model can be stored as a triangular mesh with texture.

The method uses realistic computer graphics simulation 120 to synthesize training data 130. The method has access to 3D object models 110.

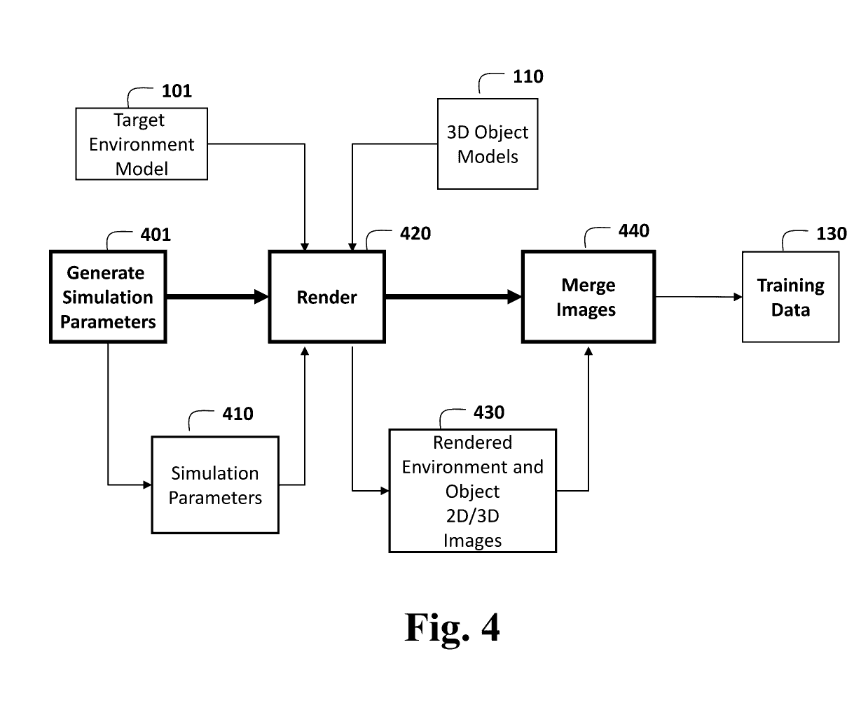

As shown in FIG. 4, the object models 110 and environment model 101 are rendered 420 using a synthetic camera placed at a location in the model corresponding to the location of the camera 205 in the target environment to obtain realistic training data representing the target environment with objects. Prior to rendering, simulation parameters 410 are generated 401 and control rendering conditions such as the camera location.

Then, the rendered object and environment images are merged 440 according to the depth ordering specifying the occlusion information to produce the training data 130. For example, the object models can represent people. Both texture and depth data can be simulated using rendering and thus both 3D and 2D classifiers can be trained.

In one embodiment, we use a library of 3D human models that are formed of triangular meshes with 3D vertex coordinates, normals, materials, and texture coordinates. In addition, a skeleton is associated with each mesh such that each vertex is attached to one or more bones, and when the bones move the human model moves accordingly.

We animate various 3D human models according to motion capture data within the target environment and generate realistic texture and depth maps. These renderings are merged 440 with 3D environment images to generate very large set of 3D training data 130 with known labels, sensor and the pose parameters 410.

One advantage is that there is no need to store the training data 130. It is much faster to render a scene, e.g., at ˜60-100 frames per second, than to read stored images. If necessary, an image can be regenerated by storing very few parameters 410 (few bytes of information) for specifying particulars for the animation and the sensor.

Although the method works particularly well for 3D sensors, which offer a particularly simplified view of the world, it can also work for training classifiers for conventional cameras, which then require sampling a wide array of lighting, clothing textures, hair colors, etc., variations.

The steps of the method described above can be performed in a processor connected to memory and input/output interfaces by buses.

Data generation is done in real time, concurrent with classifier training 140. The simulation generates new data and the training determines features from the simulated data and trains the classifier for the specified tasks, e.g., the classifier can include sub-classifiers. The classifier can be used for training various classification tasks such as object detection, object (human) pose estimation, scene segmentation and labeling, etc.

In one embodiment, the training is done in the target environment using the same processor that will be used for detecting objects. In a different embodiment, the obtained environment model is transferred to a central server using a communication network, and simulation and training is done in the central server. The trained custom environment classifier 150 is then transferred back to the object detection processor to be used in detection during classification.

In one embodiment the training can use additional training data that is collected before simulation. It can also start from a previously trained classifier and use online learning methods to customize this classifier for the new environment using simulated data.

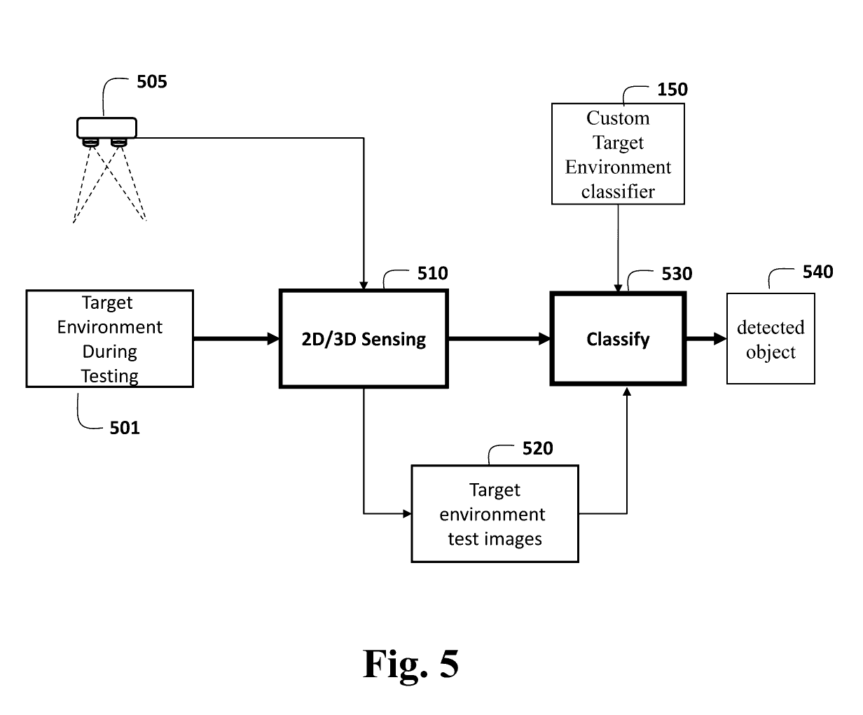

As shown in FIG. 5, during real-time operation, a sensor 505 acquires 510 a set of test images 520 of the environment. The classifier can detect and classify object 540 represented in the set of test images 520 acquired by a 2D or 3D camera 505 of a target environment 501. The set can include one or more images. The detected objects can have associated poses, i.e., locations, and orientations, as well as object types, e.g., people, vehicles, etc.

It is noted, that the test images 520 can be used as target environment model 101 to make the classifier 150 adaptive to changes in the environment and object in the environment over time. For example, a configuration of the store can be altered, and the cliental can also change, as the store caters to different customers.

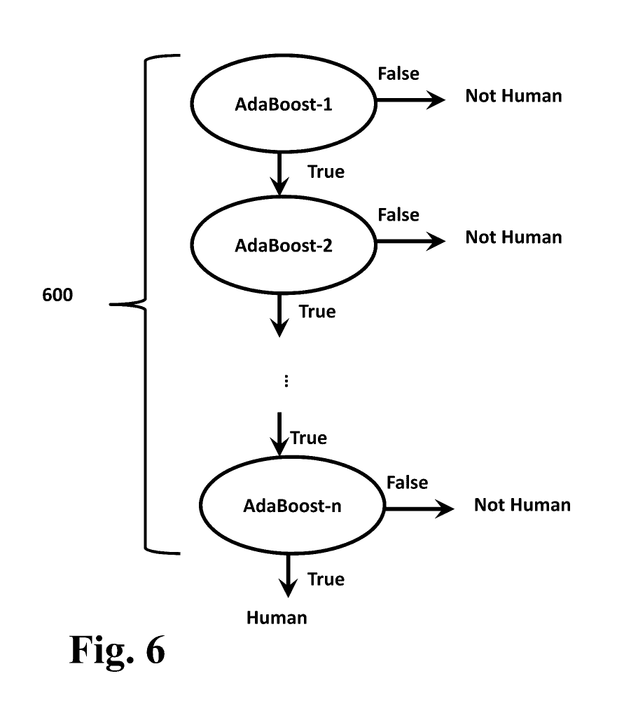

FIG. 6 shows an example trained classifier. In one embodiment, our classifier is based on AdaBoost (Adaptive Boosting). AdaBoost is a machine learning method using a collection of “weak” classifiers, see e.g., Freund et al., “A Decision-Theoretic Generalization of On-Line Learning and an Application to Boosting,” Journal of Computer and System Sciences 55, pp. 119-139, 1997. We combine multiple AdaBoost classifiers using a rejection cascade structure 600.

In a rejection cascade, to be classified as positive (true), all the classifiers should agree that the target location contains a human. The classifiers in the earlier stages are simpler, meaning fewer weak classifiers, on average, for a negative location. Thus, a small number of classifiers are evaluated to achieve real time performance.

AdaBoost learns an ensemble classifier which is a weighted sum of weak classifiers

F(x)=sign(Σᵢwᵢgᵢ(x)).

The weak classifiers are simple decision blocks using a single pair feature

gᵢ(x)=sign(fᵢ(x)−thᵢ),

the training procedure selects informative features uᵢ and vᵢ and learns classifier parameters thᵢ, and weights wᵢ.

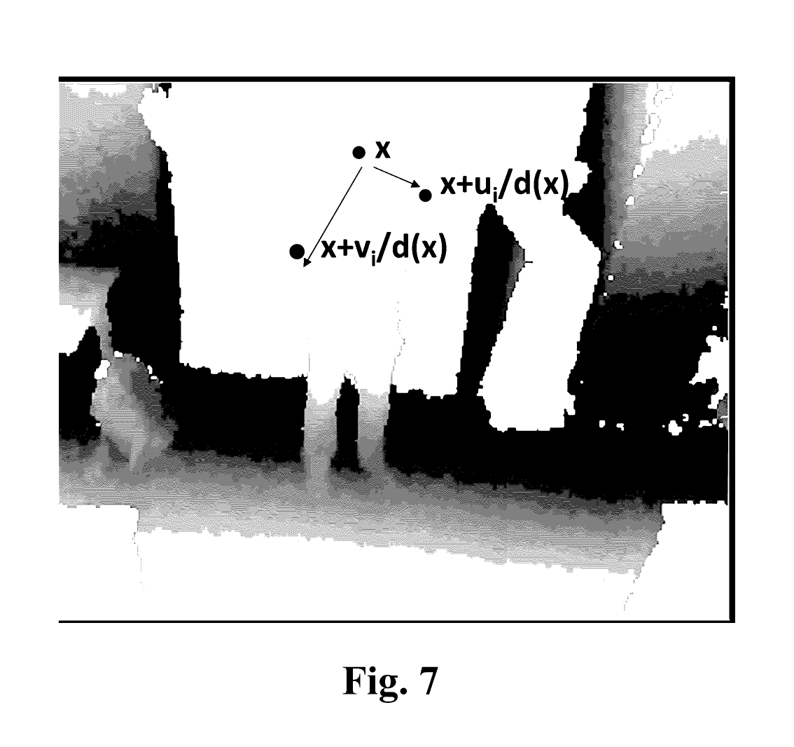

As shown in FIG. 7, we use point pair distance features

fᵢ(x)=d(x+vᵢ/d(x))−d(x+uᵢ/d(x)),

where d(x) is a distance (depth) of pixel x in the image, and vᵢ and uᵢ is a point pair specified as a shift vectors from point x. The shift vectors are specified on the image plane with respect to a root location. The shift vectors are normalized with respect to the distance of the root location from the camera such that if a root point is far, then the shift on the image plane is scaled down. The feature is the difference of depths of the two points defined by the shift vectors.

During training, we use a positive set of, e.g., 5000 humans generated synthetically using simulation platform, (includes random real backgrounds. A negative set has 10¹⁰ negative locations sampled from 2200 real images of the target environment that do not contain humans. Data are rendered in real time, and never stored, which makes the training much faster than conventional methods. There are, e.g., 49 cascade layers, and in total 2196 pair features are selected. The classifier is evaluated at every pixel in the image. Due to scale normalization based on the distance to the camera, there is no need to search at multiple scales.

### APPLICATIONS

Our classifier offers customization to a specific end user and target environment, and enables a novel business model in which end user environments are modeled, and classifiers are generated that are superior to conventional methods because the services are optimized for the environment in which they are used.

For example, a web-based service can allow the end user (customer) to self-configure a custom classifier by viewing a rendering of the 3D model of, e.g., a store, and drag and drop a 3D sensor at selected locations in the environment, which can be confirmed by obtaining a virtual sensor view.

Specific motions can be available for customer selection (running, throwing, shopping behaviors, such as selecting products and reading labels, etc. All these can be customized to the exact position and direction the customer wants, so that the detection and classification can be very precise. In our simulation 120, we can model motions, such as driving, and running, and other actions, using, e.g., different simulated backgrounds.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A method for training a classifier that is customized to detect and classify objects in a set of images acquired in a target environment, comprising:
generating a three-dimensional (3D) target environment model from a set of images of the target environment different from the acquired set of images in the target environment;
acquiring 3D object models;
synthesizing training data from the 3D target environment model and the acquired 3D object models; and
training the classifier using the training data, wherein the steps are performed in a processor.

2. The method of claim 1, wherein the set of images of the target environment for the 3D target environment model includes range images, or color images, or range and color images.

3. The method of claim 1, further comprising:
acquiring a set of test images of the target environment; and
detecting objects represented in the set of test images using the classifier.

4. The method of claim 1, wherein the set of images of the target environment for the 3D target environment model includes two-dimensional (2D) color images and three-dimensional (3D) depth images acquired by a 3D sensor in the target environment.

5. The method of claim 1, wherein the set of images of the target environment for the 3D target environment model includes stereo images by a stereo camera in the target environment.

6. The method of claim 1, wherein the 3D target environment model is stored as a point cloud.

7. The method of claim 1, wherein the 3D target environment model is stored as a triangular mesh.

8. The method of claim 7, wherein the 3D target environment model includes texture.

9. The method of claim 1, wherein the target environment and acquired 3D object models are rendered to generate object and environment images.

10. The method of claim 9, wherein the object and environment images are merged according to a depth ordering specifying occlusion information.

11. The method of claim 1, wherein the classifier is used for pose estimation.

12. The method of claim 1, wherein the classifier is used for scene segmentation.

13. The method of claim 1, wherein the training is performed at the target environment.

14. The method of claim 3, wherein the objects have associated poses, and object types.

15. The method of claim 1, wherein a previously trained classifier is adapted to the target environment using simulated data from the target environment.

16. The method of claim 3, wherein the test images are used to simulate the 3D target environment model to generate the training data to adapt the classifier over time.

17. The method of claim 1, wherein the classifier uses adaptive boosting.

18. The method of claim 1, wherein the classifier is customized using a web server.

19. A system for training a classifier that is customized to detect and classify objects in a set of images acquired in a target environment, comprising:
at least one sensor for acquiring a set of images of the target environment;
a database storing three-dimensional (3D) object models; and
a processor for generating a 3D target environment model from the set of images from the at least one sensor, synthesizing training data from the 3D target environment model and the 3D object models, and training the classifier using the training data.

20. The method of claim 1, wherein the 3D target environment model is configured for an environment for which the classifier is applied during an onsite operation by an end user.

21. The method of claim 1, wherein, the acquired 3D object models and 3D target environment model are rendered using a camera placed at a location in a 3D object model corresponding to a location of a camera in the target environment, so as to obtain training data representing the target environment with objects.

22. The system of claim 19, wherein the set of images acquired in the target environment by the at least one sensor is during real-time.
